(19) United States
(12) Patent Application Publication
(10) Pub. No.: US 2012/0312837 A1
(43) Pub. Date: Dec. 13, 2012

(54) BEVERAGE DISPENSER

(75) Inventors: Michael Zavarella, Eureka, MO (US); Jeffrey Pierson, St. Louis, MO (US)

(73) Assignee: Anheuser-Busch, LLC, St. Louis, MO (US)

(21) Appl. No.: 13/460,409

(22) Filed: Apr. 30, 2012

Related U.S. Application Data
(63) Continuation of application No. PCT/EP2010/066527, filed on Oct. 29, 2010.
(60) Provisional application No. 61/256,439, filed on Oct. 30, 2009.

(51) Int. Cl. B65D 35/28; B67D 7/06; B65D 35/56

(52) U.S. Cl. 222/95; 222/105; 222/183; 222/185.1

(57) ABSTRACT

An appliance for dispensing a liquid has a housing with two slidably connected portions allowing a liquid container to be disposed between the portions, a tap configured to be connected in a fluid connection with the container and a pressure source configured to be connected in a fluid connection with the container. The housing is configured to accommodate a liquid container.

### CLAIM OF PRIORITY

This application claims the benefit of U.S. Provisional Patent Application No. 61/256,439 filed Oct. 30, 2009 and International Application No. PCT/EP2010/066527 filed therefrom on Oct. 29, 2010.

### TECHNICAL FIELD

The present invention relates generally to dispensers for beverages for use in a consumer's home. More particularly, the present invention relates to such beverage dispensers for use with carbonated beverages such as beer or other malt beverages.

### SUMMARY OF THE PRIOR ART

For decades, breweries have sought to deliver beer and similar malt beverages to consumers in a “draught” container having a capacity much larger than conventional 12-ounce or 355 mL bottles or cans, but smaller than the conventional commercial keg (approximately 16 gallon or 60L). These draught containers serve to replicate the taste and “experience” of draught beer served in bars and restaurants. Some of these draught appliances have been configured to be refrigerated in a home refrigerator or an ice bucket, and others have been provided with specialized refrigeration appliances.

Many brewers, particularly in Europe, offer their beer in what is essentially an oversized (1 gallon or 5L) can. Although these devices are provided with an opening resembling a conventional beer tap, these “taps” do little to preserve carbonation and other freshness aspects (principally reduction of exposure to oxygen) of the beer. In the 1980's, Coors, now Miller Coors, offered beer in a 5-gallon plastic container known as a “Party Ball.” The Party Ball was tapped with a purpose-built pumping tap similar to that employed with a conventional keg. The size and pumping action required of the tap made the Party Ball inconvenient for use in a home refrigerator and the assembly did not adequately maintain beer carbonation and freshness over a period of much more than 24 hours. These offerings have constituted essentially single-use systems appropriate for serving a large group (or a large volume to a small group) over a relatively short period of time.

More recently, Heineken Supply Chain BV has offered its “DraughtKeg,” which is a metallic container having an integrated tapping apparatus. A nearly identical container, without the tapping apparatus, can be used with a purpose-built refrigerator and tapping apparatus manufactured by Krups AG and Heineken and sold under the trademark BeerTender™. The DraughtKeg, although conveniently sized and tapped, is made of expensive metal, and, according to consumer reports, does not provide for beer freshness for a period greater than a few days. The BeerTender™ appliance is expensive and, being based on the same container as the DraughtKeg, may not provide for long-term beer freshness.

Miller Coors has recently introduced a draught appliance containing beer in a self-tapped and pressurized bottle or container, which is in turn contained in a cardboard box. It is dimensioned to fit in a home refrigerator, but its aesthetic and consumer appeal is limited.

### BRIEF DESCRIPTION OF THE DRAWINGS

FIG. 1 is an isometric view of the beverage dispenser according to the present invention.

FIG. 2 is an isometric view of the appliance of FIG. 1 showing the bottle removed from the appliance.

FIG. 3 is an isometric view of the appliance of FIGS. 1 and 2 opened to admit the bottle.

FIG. 4 is a side elevation view of the beverage dispenser of FIGS. 1, 2 and 3.

FIG. 5 is an end elevation view of the beverage dispenser of FIGS. 1 through 4.

### DETAILED DESCRIPTION OF THE INVENTION

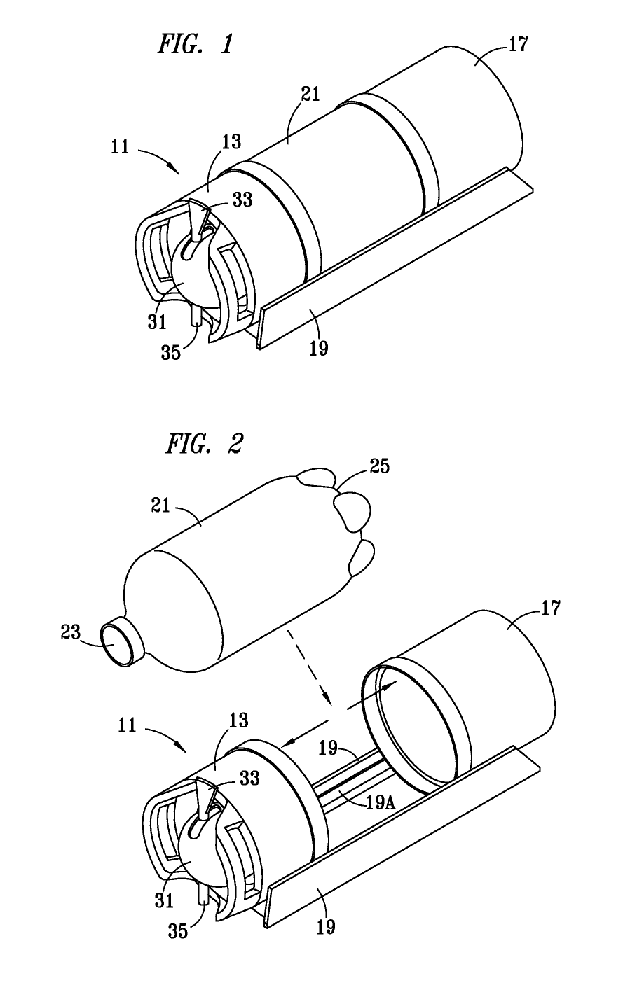

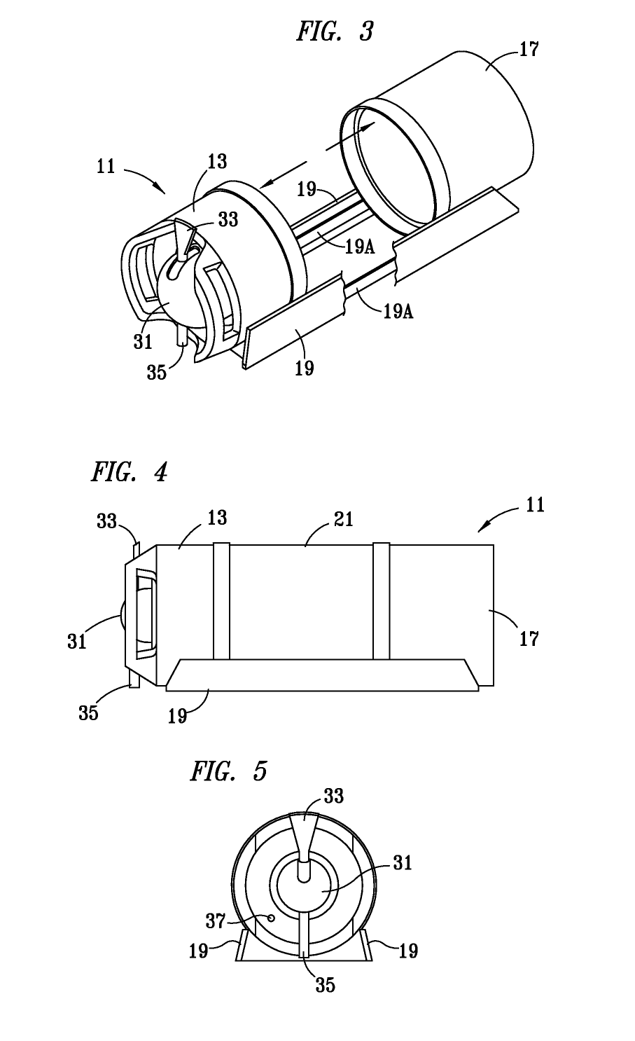

Referring now to the Figures, and particularly to FIGS. 1 though 5, the numeral 11 generally designates a beverage dispenser according to the present invention. As shown in the Figures, the beverage dispenser 11 comprises a housing having a forward, or tap portion 13 and a rear, or receptacle, portion 17. Tap and receptacle portions 13, 17 are slidably connected together for movement relative to one another (together and apart as indicated by the arrow in FIG. 2 and as shown in the open position in FIG. 3) by a base 19. Base 19 includes or comprises a pair of rails (19A in FIG. 3) along which tap 13 and receptacle 17 portions slide toward and away from one another.

A beverage bottle or container 21 (FIG. 2) may be placed and captured between tap and receptacle portions 13, 17 of the housing, and the assembly presents a unitary appearance as shown in FIGS. 1 and 4. Tap 13 and receptacle 17 portions are moved apart a sufficient distance to admit bottle 21 (FIG. 3), then moved together to enclose, capture, seat, and secure bottle 21 between them.

Bottle 21, along with the beverage contained therein, is intended to be replaced as needed, and may be disposable or refillable. As shown in FIG. 2, a preferred bottle 21 has a mouth or beverage opening and neck 23 at one end thereof, and a fluid connection 25 at a bottom or opposite end. A valve or closure mechanism is contained in neck 23 to seal and enclose liquid in bottle 21 during shipment and storage and to permit liquid to exit bottle 21 selectively upon assembly into dispenser 11. Exemplary valves or closures can be found in WO 2008/098936, WO 2008/098937, WO 2009/090223, WO 2009/090224, and WO 2009/090225.

According to the illustrative and preferred embodiment of the present invention, bottle 21 has a fluid capacity of about 3.8L and is of a “bag-in-bottle” or “bag-in-container” configuration. Accordingly, a relatively rigid outer bottle of the configuration shown contains a flexible and deformable inner container which actually contains the liquid or beverage. As the beverage is dispensed from bottle 21, the flexible inner container deforms or collapses, reducing head space or empty volume surrounding the beverage. In the case of carbonated beverages, including beer, this reduction of head space permits the beverage to retain its carbonation and minimizes exposure of the beverage to oxygen, thereby retaining its freshness.

As shown in FIGS. 1, 2 and 3, beverage dispenser 11 (and bottle 21) according to the preferred and illustrative embodiment of the present invention is intended to be horizontally oriented for accommodation on a shelf in a typical refrigerator. Likewise, bottle 21 is intended to be used in a horizontal orientation in which gravity may not be relied upon to aid beverage dispensing or to fully empty bottle 21. Therefore, a pressurized fluid, preferably gas, is vented into the space between the relatively rigid outer bottle or container and the flexible inner container. This pressurized dispensing gas is connected and supplied to the interior of bottle 21 through fluid connection 25 and applies pressure to insure the proper and complete deformation or collapse of the flexible inner container and also to provide dispensing pressure to urge the beverage out of bottle 21. The dispensing fluid or gas may take the form of pressurized or pumped air, carbon dioxide from a pressurized container (e.g. the common 12g cartridge), or the like. Similarly, the pressure source for the dispensing gas may be an electric pump, a pressurized gas cartridge, or the like.

According to a preferred and illustrative embodiment of the present invention, the dispensing gas or pressure source is air that is pressurized by an electrically driven mechanical pump contained in receptacle portion 17 of the housing. The pump is placed in fluid communication with bottle 21, more accurately the space between the relatively rigid outer container and the flexible inner container, by an opening or fluid connection 25 in the lower end of bottle 21. An exemplary fluid connection 25 formed in the bottom of bottle 21 (as well as a valve for neck 23) is illustrated and described in WO 2009/074285. Alternatively, dispensing gas can be admitted at the neck (near the beverage opening) of bottle 21 or at another location other than at the bottom of bottle 21.

The dispensing gas pump contained in receptacle portion 17 of the housing is initially powered or actuated by a contact switch, which is closed upon seating of bottle 21 within receptacle portion 17 of the housing. Seating of bottle 21 in receptacle portion 17 of the housing also effects a fluid connection between the dispensing gas pump and the interior of bottle 21. The dispensing gas pump is periodically actuated when pressure in the interior of bottle 21 (and on the flexible inner container and beverage therein) falls below a selected threshold. This dispensing gas pump thereby maintains a selected dispensing pressure on the flexible inner container and the beverage or liquid contained therein.

As shown in FIG. 5, tap portion 13 of the housing carries a tap or dispensing assembly 31. Dispensing assembly 31 includes a tap handle 33 at an upper end thereof, and a dispensing tube or spout 35 at a lower end thereof. The purpose of tap assembly 31 is to dispense beverage from bottle 21 of dispenser 11 upon conventional manipulation or actuation of tap handle 33 (pulling it forward to open and pushing it back or releasing it to close). A fluid connection is established between the beverage contained interior of bottle 21 upon seating of bottle 21 between and in tap 13 and receptacle 17 portions of the housing. Preferably, a manipulation of tap assembly 31 (rotation between 10 and 15 degrees in the clockwise direction shown in FIG. 5) completes and fully establishes the fluid connection and communication between the beverage contained in bottle 21 and tap assembly 31, including dispensing spout 35. Beverage can then be selectively dispensed from bottle 21 by conventional manipulation of tap handle 33.

According to the preferred and illustrative embodiment of the present invention, dispensing tube or spout 35 is removable from tap assembly or housing 31 for cleaning This prevents growth of mold and bacteria in dispensing spout 35, which can lead to unhygienic conditions or a foul-tasting beverage. To prevent dispensing of beverage without spout 35 in place, spout 35 may be removed only when the fluid connection between tap assembly 31 and bottle 21 is broken and tap portion 17 is removed from bottle 21. That is, after tap assembly 31 is rotated counterclockwise 10-15 degrees to disconnect bottle 21 from tap assembly 31 and tap portion 13 of the housing is separated from bottle 21.

Tap assembly 31 may also be provided with an “anti-drip” means, which employs atmospheric air or pressurized dispensing gas selectively applied to either “break the vacuum” in or “blow out” spout or dispensing tube 35. This prevents beverage from continuously dripping from spout 35 after beverage is dispensed and helps maintain the cleanliness of spout 35. Exemplary anti-drip mechanisms can be found in WO 2009/074285 and U.S. Pat. No. 7,093,470.

An indicator light 37, in the form of an LED, is also located on the forward face of tap portion 13. Light 37 may be electrically coupled to the dispensing gas pump in receptacle portion 17 of the housing, as well as to a contact or pressure sensor contained in the tap assembly 31 or tap portion 13 of the housing. Light 37 thus indicates when bottle 21 is fully seated between tap 13 and receptacle 17 portions of the housing and fluid communication is established between the dispensing gas pump or other pressure source and the interior of bottle 21, and between tap assembly 31 and neck 23 and the liquid contained in bottle 21. For example, light 37 may remain red until seating is complete and the fluid connections and communications are established, at which point the light turns green to indicate that dispenser 11 is ready to dispense the beverage. A similar indicator light can be provided in receptacle portion 17 to indicate proper seating of bottle 21 therein, and to indicate whether the dispensing gas pump has power (e.g. is plugged in or has adequate battery power).

As noted, the beverage dispenser according to the present invention provides a consumer-friendly beverage dispensing appliance or apparatus that is adapted to be oriented horizontally and stored conveniently in a household refrigerator. The bag-in-bottle configuration, the dispensing gas pump, and features of the tap or dispensing assembly combine to maintain the freshness and carbonation of a beverage contained in the bottle for upward of 30 days. Further, replacement beverage-filled bottles can be purchased by a consumer to ensure a fresh and continuous supply of draught beverage.

The invention has been described with reference to a preferred and illustrative embodiment thereof. Those skilled in the art will recognize that the invention is thus not limited, but is susceptible to variation and modification without departing from the scope of the invention.

1. An appliance for dispensing a liquid comprising:
a housing for accommodating a liquid container, the housing having two portions slidably connected to each other allowing the container to be disposed between the portions;
a tap configured to be connected in a fluid connection with the container; and
a pressure source configured to be connected in a fluid connection with the container.

2. The appliance according to claim 1, wherein the housing is configured to accommodate a liquid container of the type having a rigid outer container and a flexible inner container containing the liquid to be dispensed, and a space defined between the inner bag and outer container.

3. The appliance according to claim 2, wherein the tap is configured to be connected in fluid connection with an inner space of the inner container; and wherein the pressure source is configured to be connected to the space between the inner and the outer containers.

4. The appliance according to claim 1, wherein the slidable connection permits the two portions to move toward and away from one another to allow the container to be disposed between the two portions.

5. An appliance for dispensing a beverage comprising:
a housing having a tap portion and a receptacle portion, the tap and receptacle portions being secured together and movable relative to one another;
a bottle containing the beverage, the bottle having a beverage opening and a fluid connection, the bottle being selectively received in the housing between the tap and receptacle portions and being secured in the housing by relative movement between the tap and receptacle portions toward one another;
a pressurized fluid source in the housing, the fluid source being placed in fluid communication with the fluid connection of the bottle upon receipt of the bottle in the housing;
a tap configured to selectively dispense the beverage, the tap carried by the tap portion of the housing and being placed in fluid communication with the beverage upon receipt of the bottle in the housing.

6. The appliance according to claim 5, wherein the bottle has a generally rigid outer container and a flexible inner container within the outer container that deforms as beverage is dispensed.

7. The appliance according to claim 6, wherein the fluid source is disposed in the receptacle portion and applies pressurized fluid through the fluid connection to a space between the inner and outer containers of the bottle.

8. The appliance according to claim 5, wherein the fluid source is an electrically-powered air pump.

9. The appliance according to claim 5, wherein the tap portion and receptacle portion are secured together by a base and move together and apart along the base.

10. The appliance according to claim 5, wherein the tap is rotated relative to the tap portion to effect a fluid connection with the bottle.

11. The appliance according to claim 5 further comprising:
a dispenser spout carried by the tap portion, the spout configured to be removed from the tap portion upon the tap being disconnected from fluid communication with the bottle.

12. A method of dispensing a beverage contained in a bottle from a tap separate from the bottle, the method comprising the steps of:
placing the bottle in a housing;
securing the bottle in the housing by movement of a tap portion of the housing relative to a receptacle portion of the housing;
pressurizing the beverage contained in the bottle by selectively actuating a pressurized fluid source contained in the housing;
establishing fluid communication between the tap and the bottle by manipulating the tap relative to the tap portion of the housing;
dispensing the beverage by actuating the tap after the bottle is secured in the housing and fluid communication is established between the tap and the bottle; and
removing the bottle from the housing by moving the tap portion away from the receptacle portion.

13. The method of claim 12, further comprising the step of:
removing a spout from the tap portion by manipulating the tap to disconnect it from fluid communication with the bottle, and separating the tap portion from the bottle.
